(19) United States
(12) Patent Application Publication
(10) Pub. No.: US 2006/0155822 A1
(43) Pub. Date: Jul. 13, 2006

(54) System and method for wireless access to an application server

(75) Inventors: Jen-Shun Yang, Hsinchu (TW); Da-Jiun Chou, Taipei (TW); Chun-Chieh Wang, Kaohsiung (TW)

Correspondence Address: QUINTERO LAW OFFICE, 1617 BROADWAY, 3RD FLOOR, SANTA MONICA, CA, 90404, US

(73) Assignee: INDUSTRIAL TECHNOLOGY RESEARCH INSTITUTE, Hsinchu (TW)

(21) Appl. No.: 11/240,308

(22) Filed: Sep. 29, 2005

(30) Foreign Application Priority Data
Jan. 11, 2005 (TW) TW94100711

(51) Int. Cl. G06F 15/167

(52) U.S. Cl. 709/216; 370/395.53

(57) ABSTRACT

A communication method, comprising constructing a Virtual Private Network (VPN) tunnel between a mobile device and an Intranet; and performing an Extensible Authentication Protocol-Subscriber Identification Module (EAP-SIM) authentication through the VPN tunnel. Access right of target service can be verified according to information in a SIM card no matter what kind of network access technology the service subscriber is using with the proposed communication method. A system utilizing the method is further provided.

### BACKGROUND

The invention relates in general to server access, and in particular to a system and method for wireless access to an application server.

Owing to the growing popularity of Wireless Local Area Network (WLAN), merging of WLAN technology into cellular networks has become popular. Concerns remains regarding the insecure nature of data access in wireless networks such as WLAN. Typically, Extensible Authentication Protocol-Subscriber Identification Module (EAP-SIM) authentication is applied to resolve the authentication issue of network security.

Conventionally, SIM-based authentication, authority and accounting (AAA) of a dual network is accomplished through an EAP-SIM, with the collaboration of cellular network operators and WLAN operators. To date there is still no viable solution for service providers, such as Voice over IP (VoIP) or Internet Online Gaming providers, to incorporate authentication of service applications into EAP-SIM based AAA method. When a dual network user roams into a WLAN or a Public WLAN (PWLAN) owned by a non-SIM card distributor, the user cannot execute the EAP-SIM based authentication procedure at the application level, despite the service provider having authentication rights for both SIM card and application access.

FIG. 1 is a flowchart of a conventional EAP-SIM authentication procedure in a system incorporating peer station 90 and authenticator 91. Authenticator 91 takes an initiative to release EAP-Request/Identity Packet 900, peer station 90 responds with EAP-Response/Identity Packet 902, containing typically an International Mobile Subscriber Identity (IMSI) or a temporary identity of peer station 90. Authenticator 91 then transmits EAP-Request/SIM/Start Packet 904, comprising a list of supported authentication versions at authenticator 91. In response, peer station 90 replies with EAP-Request/SIM/Start Packet 906, comprising a random number and a selected authentication version. Authenticator 91 exchanges messages with the authentication center (AuC) (not shown) of Global System for Mobile Communications (GSM) network, computing a session key, and sending EAP-Request/SIM/Challenge Packet 908, comprising a randomized challenge and a Message Authentication Code (MAC) protecting the challenge. Upon receiving Packet 908, peer station 90 performs GSM algorithm to verify MAC and derive the session key, returning EAP-Response/SIM/Challenge Packet 912 comprising resultant MAC for a successful authentication. Authenticator 91 in turn compares the received MAC with the transmitted MAC, and returns EAP-Success Packet 914 if the two MACs are consistent, at which time the EAP-SIM authentication is successful.

Technology in the relevant field includes a billing method for network telecommunication employing SIP authentication, as disclosed in US patent US2002/0146005A1, and a authentication proxy architecture for a Web-based wireless intranet applications disclosed in U.S. Pat. No. 6,732,105B1. Nevertheless, conventional technology does not provide security mechanism during authentication, nor is it applicable for accessing every application level service in an intranet. Thus, there is neither support for application level authentication nor secure access to the application servers under dual network architecture.

### SUMMARY

A communication method between a mobile device and a Intranet is provided. The communication method comprises constructing a Virtual Private Network (VPN) tunnel between the mobile device and the Intranet, and executing an Extensible Authentication Protocol-Subscriber Identification Module (EAP-SIM) authentication therethrough.

A communication system is also provided, comprising a mobile device sending a request for an application, and a Intranet receiving the request and establishing an Internet connection with the mobile device, constructing a Virtual Private Network (VPN) tunnel in the Internet connection, and executing EAP-SIM authentication therethrough.

### BRIEF DESCRIPTION OF THE DRAWINGS

The invention will become more fully understood from the detailed description, given hereinbelow, and the accompanying drawings. The drawings and description are provided for purposes of illustration only and, thus, are not intended to limit the present invention.

FIG. 1 is a flowchart of a conventional EAP-SIM authentication.

FIG. 2 is a block diagram of an embodiment of system deployment according to the invention.

FIG. 3A-3B are detailed flowcharts of an embodiment of the invention.

FIG. 4 is a block diagram of a mobile device module, according to an embodiment of the invention.

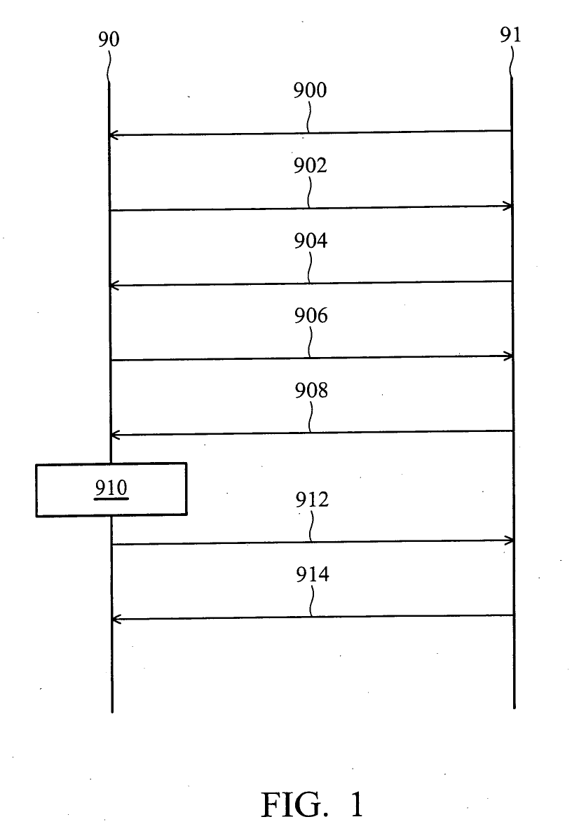

### DETAILED DESCRIPTION

The invention provides a method and system for accessing an application server in an Intranet. In terms of providing secure network access, it utilizes Virtual Private Network (VPN) tunneling for security, through which application authentication can be conducted through it using EAP-SIM authentication.

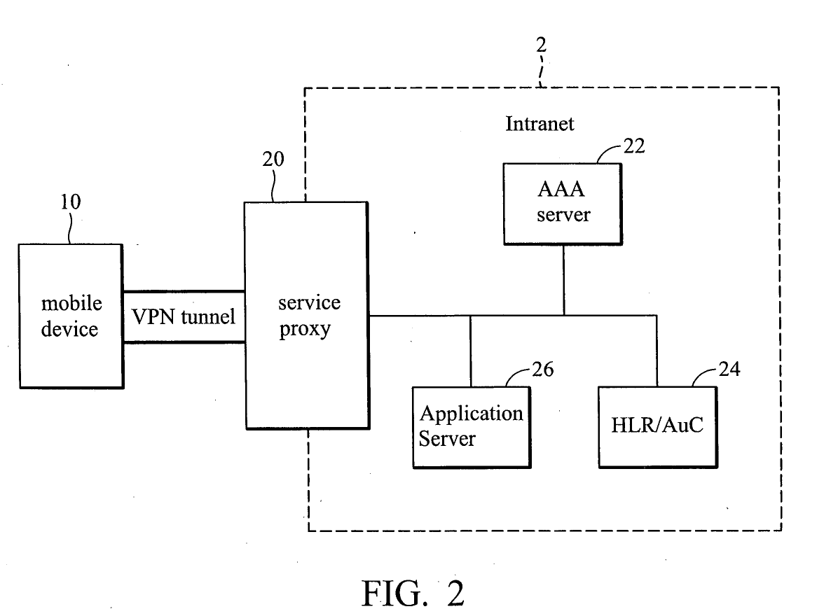

FIG. 2 is a diagram of a system for accessing application server according to an embodiment of the present invention, the system comprising a mobile device 10, a service proxy 20, an Authentication, Authority and Accounting (AAA) server 22, a Home Location Register/Authentication Center (HLR/AuC) server 24, and an application server 26.

Mobile device 10 is a service subscriber of a service application in an intranet. Service proxy 20 is a gateway server in the intranet. AAA server 22 is responsible for authentication, authority, and accounting. HLR/AuC server 24 manages user profiles and authentication information. Application server 26 provides various service applications in the intranet. The intranet may be a WLAN.

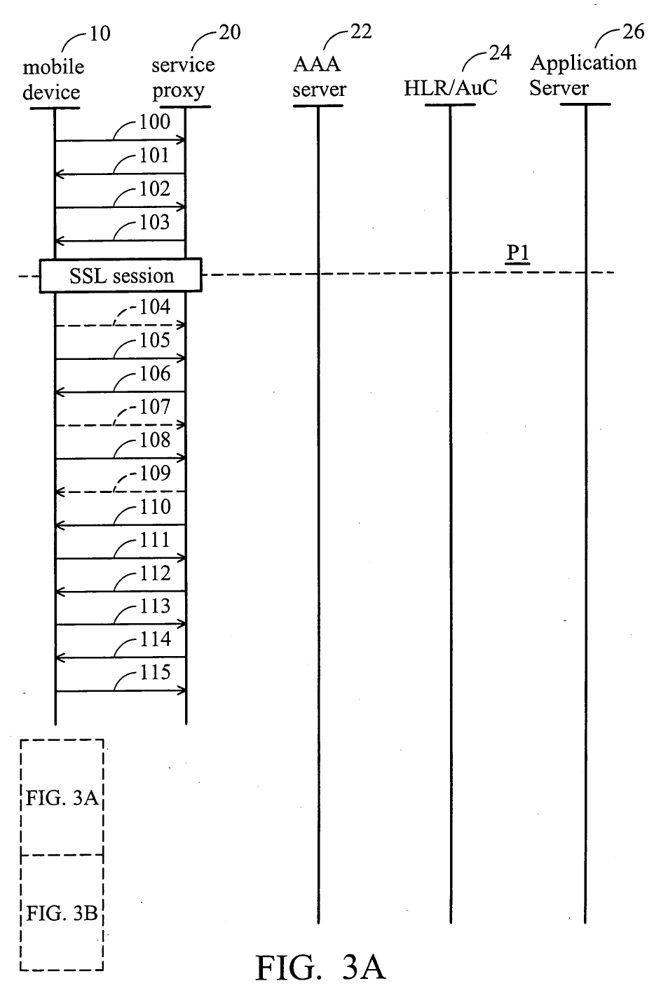

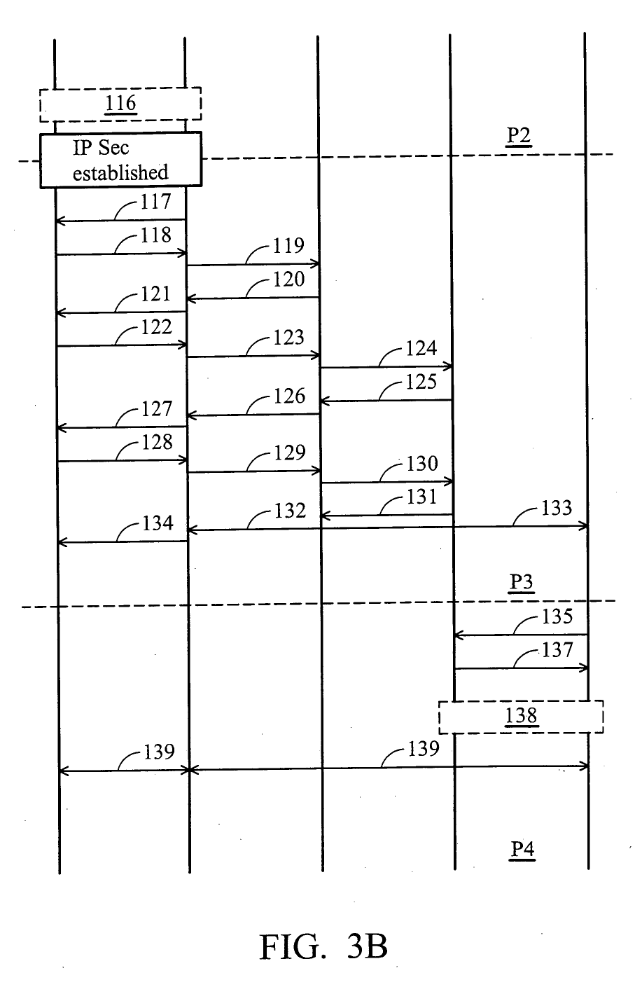

FIG. 3 is a flowchart of a method for accessing application server in an embodiment of the present invention. The access flow is applicable to a system in FIG. 2, and is disclosed in four phases for explanation. A secure socket layer (SSL) connection is established between a mobile device and a service proxy in the first phase P1. A virtual private network (VPN) connection is further established in the second phase P2. In the third phase P3 an application level authentication is carried out by means of EAP-SIM authentication. For successful authentication, the temporary VPN tunnel is validated, and data transmission therethrough is granted in the fourth phase P4.

In phase P1, a secure socket layer (SSL) session is established between a service subscriber and a service proxy to secure subsequent data transmission, whereby security of data transaction in the second phase P2 is ensured. The service subscriber may be a mobile device. The service proxy may be a proxy server in an intranet.

In phase P2, a temporary VPN tunnel is initiated within the SSL session. The VPN tunnel may be realized with Layer 2 Tunneling Protocol (L2TP) and IP Security Protocol (IPSec). The L2TP secured by IPSec may operate in either main mode or aggressive mode, in which the main mode provides more data security than the aggressive mode, at the expense of slower VPN session establishment. The main mode utilizes two message transmissions comprising a protected identity and a key separately for service subscriber, whereas the aggressive mode completes the transmission of an unprotected identity and a key in one message, rendering faster IPSec security association (SA). As the aggressive mode of IPSec negotiation is deployed, the security of subscriber identity is provided via the SSL session. Implementation of the VPN tunnel is not intended here to limit the invention, as those skilled in the art may choose other VPN implementations.

In the third phase P3, authentications for EAP-SIM and service applications are verified. Upon successful authentication of EAP-SIM and service applications, the temporary VPN tunnel is validated and application data is transmitted therethrough. For unsuccessful authentication, the temporary VPN tunnel is removed and data transmission is terminated.

Instead of embedding only the service subscriber identity, or International Mobile Subscriber Identity, into EAP-response/Identity packet, information requesting the access rights to the service application in the intranet is also attached to the packet. The requested access information may be an address of the application server and a communication port for the application service. Upon completion of SIM number verification, the AAA server forwards access-request packet 130 containing the access information to the HLR/AuC server, and receives packet 131 including intranet access information of the service subscriber from the HLR/AuC server. If the subscriber has access rights to the service application, the HLR/AuC server issues access-accept in packet 131, the AAA server delivers EAP-success packet 132 to the subscriber and redirects the access-accept packet 133 to the application server. The application server then requests user profile with packet 135 from the HLR/AuC server, accepts and sets up working environment based on the user profile packet 137, and transfers data of the authenticated service with the subscriber. The application server may carry out further actions based on the information in the access-accept packet.

In the fourth phase P4 the service application data is transmitted between the mobile device and the application server via service proxy, where the security of the data is provided via the VPN tunnel.

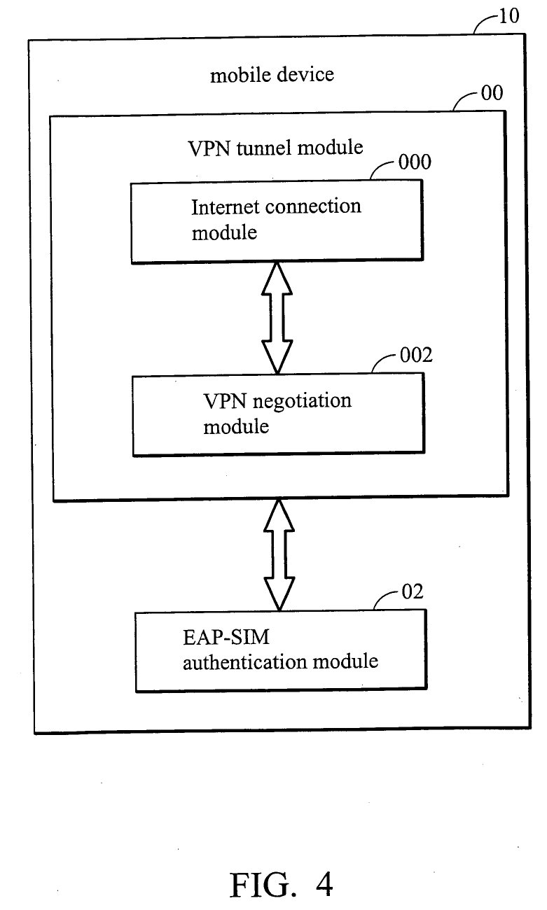

FIG. 4 is a block diagram of a mobile device module 10, according to an embodiment of the invention, comprising a Virtual Private Network (VPN) tunnel module 00 establishing VPN tunnel with a Intranet, and an EAP-SIM authentication module 02 performing EAP-SIM authentication therethrough. VPN tunnel module 00 comprises an Internet security module 000 and a VPN security module 002, in which Internet security module 000 establishes security sessions with an internet encryption algorithm, and VPN security module 002 exchanges a VPN security negotiation in the security session. The internet encryption algorithm may be accomplished through Secure Socket Layer. The VPN security negotiation may be implemented with L2TP and IPSec protocol. EAP-SIM authentication module 002 delivers SIM identity and requested access information of the mobile device. The access information may be an address of the application server and a communication port for the application service.

Mobile device module 10 in FIG. 4 may be realized through software implementation, hardware implementation, or a combination thereof.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communication method between a mobile device and a Intranet, comprising:
constructing a Virtual Private Network (VPN) tunnel between the mobile device and the Intranet; and executing an Extensible Authentication Protocol-Subscriber Identification Module (EAP-SIM) authentication through the VPN tunnel.

2. The communication method of claim 1, wherein the constructing step comprises:
establishing an Internet connection; and
exchanging a VPN negotiation in the Internet connection.

3. The communication method of claim 2, wherein the Internet connection is a security session.

4. The communication method of claim 2, wherein the VPN negotiation is protected by a Tunneling Protocol and a IP Security Protocol.

5. The communication method of claim 4, wherein the VPN negotiation employs aggressive mode in the IP Security Protocol.

6. The communication method of claim 1, wherein the executing step comprises:
sending a first packet from the Intranet to the mobile device;
receiving a second packet with sender identity as an acknowledgement from the mobile device to the Intranet;
transmitting a third packet with an authentication version list from the Intranet to the mobile device;
directing a fourth packet with an authentication version from the mobile device to the Intranet;
transmitting a fifth packet with a randomized Message Authentication Code (MAC) from the Intranet to the mobile device;
receiving a sixth packet with a MAC from the mobile device at the Intranet; and
issuing a seventh packet from the Intranet to the mobile device, if the MAC is confirmed.

7. The communication method of claim 6, wherein the executing step further comprises accepting requested access information from the mobile device at the Intranet.

8. The communication method of claim 1, wherein the mobile device is a wireless electronic device.

9. The communication method of claim 1, further comprises forwarding an user profile of the mobile device, from a Home Location Register/Authentication Center (HLR/AuC) server in the Intranet to an application server in the Intranet, if the EAP-SIM authentication succeeds.

10. The communication method of claim 6, further comprising:
delivering access information of the mobile device, from a HLR/AuC server in the Intranet to an Authentication, Authorization, and Accounting (AAA) server in the Intrenet;
rejecting the EAP-SIM authentication, if the requested access information does not correspond to the access information; and
accepting the EAP-SIM authentication, if the requested access information corresponds to the access information.

11. A communication system, comprising:
a mobile device sending a request; and
an Intranet receiving the request for the application, establishing an Internet connection with the mobile device, constructing a Virtual Private Network (VPN) tunnel in the Internet connection, and executing EAP-SIM authentication therethrough.

12. The communication system of claim 11, wherein the Intranet comprises:
a proxy server coupled to the mobile device through the VPN tunnel;
an Authentication, Authorization, and Accounting (AAA) server coupled to the proxy server, and providing EAP-SIM authentication information to the proxy server;
a Home Location Register/Authentication Center (HLR/AuC) server coupled to the AAA server, and storing access information and user profile; and
an application server coupled to the proxy server, the AAA server, and the HLR/AuC server, receiving the EAP_SIM authentication information from the AAA server, accepting the user profile from the HLR/AuC server, and carrying out an application if EAP_SIM authentication is accepted.

13. The communication system of claim 12, wherein the AAA server accepting access information of the mobile device from the HLR/AuC server.

14. A mobile device for accessing service application in a WLAN, comprises:
a Virtual Private Network (VPN) tunnel module, for establishing a VPN tunnel to the Intranet; and
an EAP-SIM authentication module coupled to the VPN tunnel module, and executing EAP-SIM authentication through the VPN tunnel.

15. The mobile device of claim 14, wherein the VPN tunnel establishing module comprises:
an Internet connection module, establishing an Internet connection; and
a VPN negotiation module, exchanging VPN negotiation via the Internet connection.

16. The mobile device of claim 15, wherein the Internet connection is a security session.

17. The mobile device of claim 15, the VPN negotiation is protected by any Tunneling Protocol and any IP Security Protocol.

18. The mobile device of claim 14, wherein the EAP-SIM authentication module further delivers requested access information to the Intranet.
